(19) United States
(12) Patent Application Publication
(10) Pub. No.: US 2024/0191765 A1
(43) Pub. Date: Jun. 13, 2024

(54) SYSTEM TO PROVIDE TEMPERATURE CONDITIONED AIR TO A BRAKE ASSEMBLY

(71) Applicant: FCA US LLC, Auburn Hills, MI (US)

(72) Inventors: Uday Kiran Mahakali, Novi, MI (US); Sreekanth Surapaneni, Oakland Township, MI (US)

(21) Appl. No.: 18/065,262

(22) Filed: Dec. 13, 2022

(51) Int. Cl. F16D 65/847; B60T 5/00

(52) U.S. Cl. CPC F16D 65/847; B60T 5/00; F16D 2065/783

(57) ABSTRACT

A vehicle includes a wheel, a brake assembly, a conditioned air source and an air circuit. The brake assembly has a portion selectively engageable with the wheel to reduce the rate of rotation of the wheel or stop rotation of the wheel. The conditioned air source provides an output air flow to the air circuit. The air circuit includes a first outlet through which at least a portion of the output air flow is directed toward at least part of the brake assembly under at least some conditions of vehicle operation. Accordingly, a flow of conditioned air, which may be heated or cooled relative to ambient air, may be provided to the brake assembly.

### FIELD

The present disclosure relates to a system to provide temperature conditioned air to a vehicle brake assembly.

### BACKGROUND

Vehicles includes brake assemblies to permit selective braking of the vehicles to slow or stop the vehicles. Performance of the brake assemblies can be affected by temperature, with too high of a temperature of a brake pad or rotor or drum leading to decreased brake performance or even brake failure. In some brake assemblies, performance may also be decreased when the brake assembly components are too cold.

### SUMMARY

In at least some implementations, a vehicle includes a wheel, a brake assembly, a conditioned air source and an air circuit. The brake assembly has a portion selectively engageable with the wheel to reduce the rate of rotation of the wheel or stop rotation of the wheel. The conditioned air source provides an output air flow to the air circuit. The air circuit includes a first outlet through which at least a portion of the output air flow is directed toward at least part of the brake assembly under at least some conditions of vehicle operation. Accordingly, a flow of conditioned air, which may be heated or cooled relative to ambient air, may be provided to the brake assembly.

In at least some implementations, the conditioned air source is or includes: a) an air conditioner providing cooled air, and the output air flow includes air at a temperature below the temperature of an air input to the air conditioning assembly; or b) a heater providing heated air, and the output air flow includes air at a temperature above the temperature of ambient air. In at least some implementations, the air source provides an output of heated or cooled air.

In at least some implementations, a valve is associated with the air circuit, and the valve has multiple positions. When the valve is in at least one of the multiple positions, at least a portion of the output air flow does flow through the first outlet. In at least some implementations, the air circuit includes a second outlet spaced from the brake assembly and through which at least a portion of the output air flow is not directed at the brake assembly in at least one position of the valve. In at least some implementations, the vehicle includes a passenger compartment and the second outlet is communicated with the passenger compartment to provide at least a portion of the output air flow to the passenger compartment in at least one position of the valve. In at least some implementations, the valve controls the rate of the output air flow to the first outlet. In at least some implementations, the valve is located between the first outlet and the second outlet.

In at least some implementations, the valve includes a third position, and when the valve is in the first position the output air flow flows through the first outlet, when the valve is in the second position the output air flow flows through the second outlet and when the valve is in the third position the output air flow flows through both the first outlet and the second outlet. In at least some implementations, a controller is coupled to the valve to control when the valve is in the first position and when the valve is in the second position, or when the valve is in the third position.

In at least some implementations, a switch is provided that has multiple states, and, in at least one state of the switch, the valve is in said at least one position in which at least a portion of the output air flow does flow through the first outlet. In at least one other state of the switch, the valve is in a position that prevents the output air flow from flowing through the first outlet.

In at least some implementations, a temperature sensor is associated with at least part of the brake assembly, the temperature sensor is coupled to the controller, and the controller is responsive to an output of the temperature sensor outboard of a threshold to cause the valve to be in the at least one position in which at least a portion of the output air flow does flow through the first outlet. In at least some implementations, the controller is coupled to the conditioned air source and the controller provides a signal to turn on the conditioned air source if the conditioned air source is not then operating or to ensure the conditioned air source continues operating, to provide the output air flow from the conditioned air source. In at least some implementations, the vehicle has multiple performance modes, and in at least one of the multiple performance modes, the controller ensures the conditioned air source is operating to provide the output air flow and the valve is in said at least one position in which at least a portion of the output air flow does flow through the first outlet.

In at least some implementations, the vehicle includes a passenger compartment, and the air circuit includes a second outlet communicated with the passenger compartment to provide at least part of the output air flow into the passenger compartment under at least some conditions of vehicle operation. In this way the output from the conditioned air source may be provided to one or both of the brake assembly and the passenger compartment.

In at least some implementations, the brake assembly includes a rotor and a brake pad that is selectively engageable with the rotor, and wherein, when the output air flow flows through the first outlet, the output air flow is directed at the rotor.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a perspective view of part of a vehicle including multiple wheels, at least one brake assembly and a passenger compartment.

FIG. 2 is a perspective view of part of the vehicle, showing brake assemblies for front wheels of the vehicle and part of an air circuit;

FIG. 3 is an enlarged, fragmentary view showing part of a brake assembly and part of the air circuit including a brake outlet; and

FIG. 4 is a diagrammatic view of a system providing temperature controlled air to a brake assembly and a passenger compartment of a vehicle.

### DETAILED DESCRIPTION

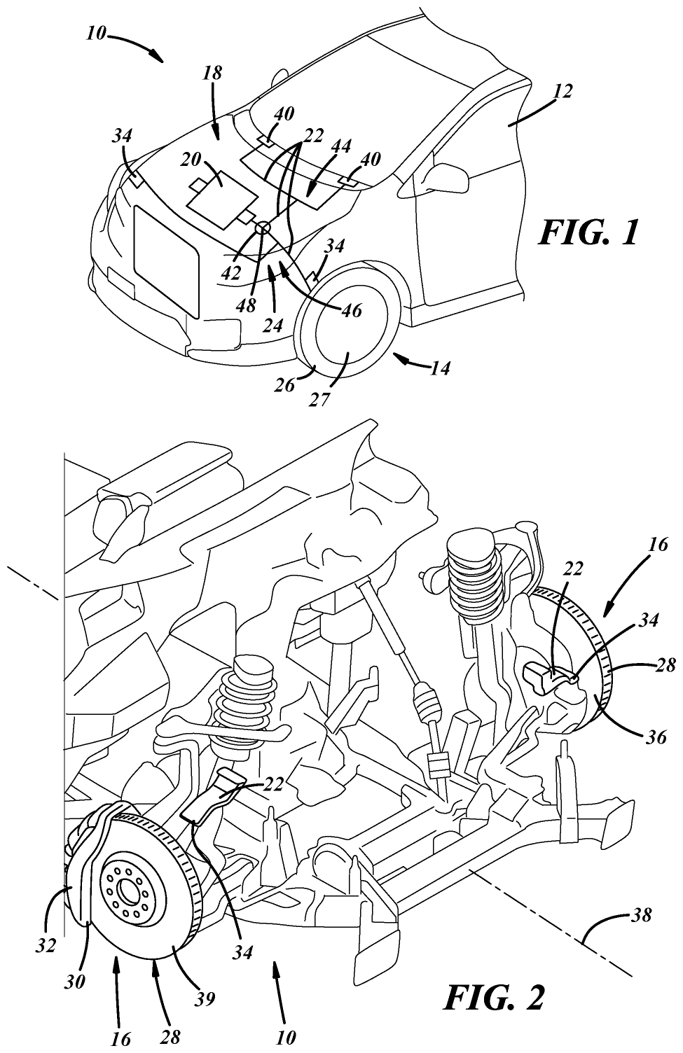

Referring in more detail to the drawings, FIG. 1 illustrates a vehicle 10, shown as a passenger vehicle 10 with a passenger compartment 12 that may be defined at least in part by doors and windows, in the usual manner. The vehicle 10 also has multiple wheels 14 that roll along a road surface as the vehicle 10 moves, and a brake assembly 16 (FIG. 2) associated with one or more of the wheels 14 to enable slowing and stopping of the vehicle 10. As set forth in more detail herein, the vehicle 10 also includes a system 18 that provides conditioned, temperature-controlled air to the vehicle 10 brake assemblies 16 to selectively heat or cool at least part of a brake assembly 16.

The system 18 includes a source 20 of conditioned air that may provide an output flow of air into the passenger compartment 12 of the vehicle 10 that may be at a different temperature, warmer or cooler, than the ambient air temperature outside of the vehicle 10. The conditioned air source 20 may be a HVAC unit, such as are common in passenger vehicle 10 and may include one or both of an air conditioner/air conditioning assembly and a heater/heating assembly. The conditioned air source 20 functions to provide output air at a temperature and rate to, among other things, provide a desired temperature within the passenger compartment 12. The conditioned air source 20 may be of any desired construction and arrangement and include any number of passages 22 in one or more components (e.g. ducts, conduits, vents, etc). Collectively, the passages 22 define an air circuit 24 through which the output air flow may be distributed about the vehicle 10 as desired.

The vehicle wheels 14 may include tires 26 mounted on rims 27 that are coupled to a suspension system of the vehicle 10. A brake assembly 16 is associated with one or more, and usually all wheels 14, of the vehicle 10. The brake assembly 16 may be a disc brake or drum brake and a vehicle 10 may have a combination of disc and drum brakes. As shown in FIG. 2, a disc brake assembly 16 includes a disc-shaped rotor 28 that is coupled to and rotates with the wheel, and a brake pad 30 movable by a caliper assembly 32 so that the brake pad 30 is selectively engageable with the rotor 28 to reduce or stop rotation of the rotor 28 and thus, the wheel. A drum brake assembly 16 includes a brake drum and one or more brake shoes that are selectively engageable with the drum to reduce or stop rotation of the brake drum and thus, the wheel. The brake assembly 16 or assemblies may be of conventional construction.

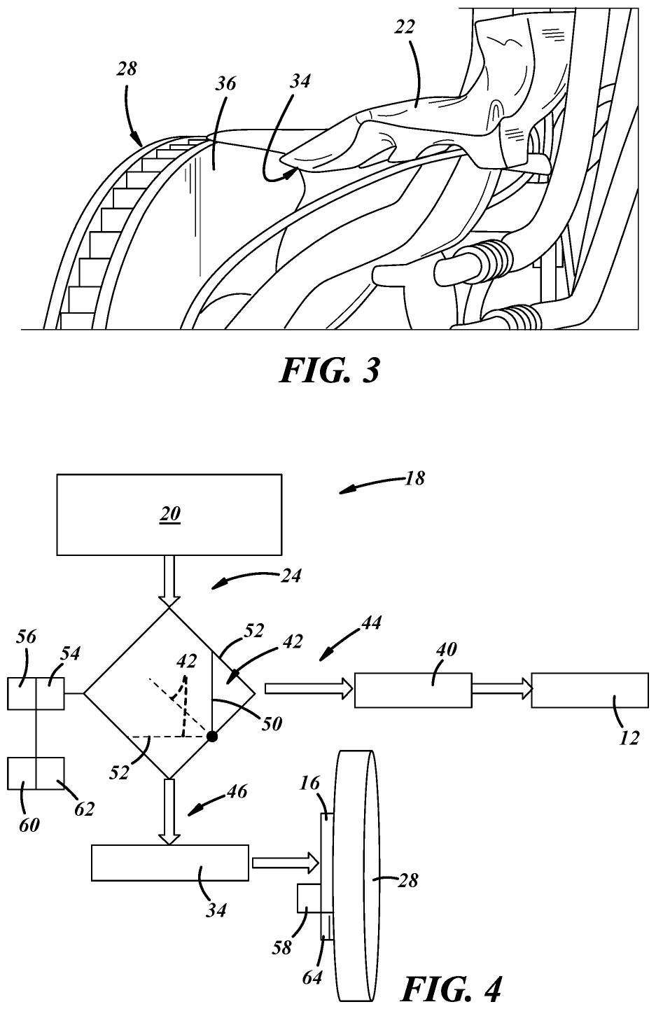

As shown in FIGS. 1-3, the air circuit 24 may include multiple, interconnected passages 22 to route the output air flow from the conditioned air source 20 to different locations of the vehicle 10. A first passage includes a brake outlet 34 that is arranged so that output air flow that exits the brake outlet 34 flows toward and engages at least part of the brake assembly 16. In the example shown, the brake outlet 34 directs conditioned air onto the brake rotor 28, to affect the temperature of the brake rotor 28. Further, in the example shown the brake outlet 34 is arranged to direct output air flow onto an inboard side 36 of the brake rotor 28 which is a side of the brake rotor 28 that is closest to a fore-aft centerline 38 of the vehicle 10. The brake outlet 34 could also or instead direct air flow onto a periphery of the brake rotor 28 or an opposite outboard side 39 of the brake rotor 28 which faces and is closer to the exterior of the vehicle 10 than is the inboard side. Further, multiple brake outlets 34 may be provided to direct air flow onto different areas of the brake assembly 16, as desired. As shown in FIG. 2, a similar arrangement of a separate brake outlet 34 may be provided for the brake assembly 16 (e.g. directed at the brake rotor 28) associated with a different wheel of the vehicle 10 and brake outlets 34 of the air circuit 24 may be provided on multiple and up to all brake assemblies 16 of the vehicle 10.

As shown in FIGS. 1 and 4, the air circuit 24 may also include other outlets, including one or more outlets 40 arranged to direct conditioned, output air flow into the passenger compartment 12 of the vehicle 10. This may be done through any number of components, like conduits and ducts, with passenger compartment outlets 40 that open into the passenger compartment 12 to facilitate heating or cooling of the passenger compartment 12, in known manner.

As shown in FIG. 4, to permit control over the output air flow among the various outlets of the air circuit 24, a valve 42 may be provided in the air circuit 24. In at least some implementations, the air circuit 24 includes a first portion 44 that includes the passenger compartment outlets 40 and a second portion 46 that includes the brake outlets 34, and the valve 42 may be located in or associated with a junction 48 between the first portion 44 and second portion 46. The valve 42 has multiple positions. Among the multiple positions, in at least some implementations, the valve 42 may have: a) a position in which output air is directed only to the first portion 44 of the air circuit 24, to supply air to the passenger compartment outlets 40; b) a position in which output air is directed only to the second portion 46 of the air circuit 24, to supply air to the brake outlets 34; and c) at least one position that permits at least some output air flow to both the first and second portions 44, 46 of the air circuit 24. The valve 42 may be of any desired construction, such as but not limited to, a butterfly type valve 42 having a disc-shaped valve 42 head 50 (labeled in FIG. 4, and shown in dashed lines to represent alternate positions) movable relative to one or move valve seats 52. While one valve 42 is shown in the drawings, multiple valves 42 may be provided to control air flow to any number of the outlets of the air circuit 24. In much of the further description, a single valve 42 will be referenced, for simplicity, but, as noted, more than one valve 42 may be provided if desired.

To facilitate control of the valve 42 (or valves 42), as shown in FIG. 4, the valve 42 may be electrically actuated and the valve 42 may be coupled (wired or wirelessly) to a controller 54 that provides an output to the valve 42 capable of changing the position of the valve 42. The controller 54 may include or be communicated with a memory 56 that can store instructions for valve 42 operation. Various microcontrollers or microprocessors may be used as is known to those skilled in the art. The memory 56 may be of any desired type, such as a reprogrammable or flash EEPROM (electrically erasable, programmable read-only memory). The memory 56 should be construed broadly to include other types of memory such as RAM (random access memory), ROM (read-only memory), EPROM (erasable, programmable, read-only memory), or any other suitable non-transitory computer readable medium.

Various inputs may be provided to the controller 54 to facilitate control of the valve 42. For example, a temperature sensor 58 may be coupled to or otherwise associated with at least part of the brake assembly 16, and communicated with the controller 54 to provide a signal indicative of a temperature of or near part of the brake assembly 16. In at least some implementations, the controller 54 is responsive to an output of the temperature sensor 58 indicative of a temperature beyond a threshold to cause the valve 42 to move to a position in which at least some of the output air flows into the second portion 46 of the air circuit 24, to direct conditioned air at one or more brake assemblies 16. The system may include, for example, a high temperature threshold and be responsive to a signal from the sensor 58 indicating a temperature above the high temperature threshold (e.g. a portion of the brake assembly 16 is too hot). The system may also or instead include a low temperature threshold and be responsive to a signal from the sensor 58 indicating a temperature below the low temperature threshold (e.g. a portion of the brake assembly 16 is too cold).

In this regard, because the conditioned air source 20 might not be operating when the temperature that is beyond a threshold is sensed, the controller 54 may also be coupled to the conditioned air source 20 and capable to turn on the conditioned air source 20 when needed, or to maintain the conditioned air source 20 in an operating mode when needed. That is, the controller 54 may be programmed to ensure that the conditioned air source 20 remains on until the sensed temperature is no longer outboard of the threshold. In a system with multiple valves 42, separate sensors 58 may be provided for each of multiple brake assemblies 16 and the associated valves 42 may be controlled separately to provide conditioned output air to individual brake assemblies 16, as needed.

In at least some implementations, the vehicle 10 may include multiple performance modes, and when the vehicle 10 is being operated in at least one of the multiple performance modes, the controller 54 ensures the conditioned air source 20 is operating to provide the output air flow and the controller 54 moves or keeps the valve 42 is in a position in which at least a portion of the output air flows to the second portion 46 of the air circuit 24. For example, the vehicle 10 may include a high-performance mode like a sport or track mode, and the controller 54 may provide cooled air flow to the brake assemblies 16 when the vehicle 10 is in such a mode to help reduce the temperature of brakes that become hot during high performance vehicle driving. The system may also initially provide heated air to the brake assemblies 16 if performance driving is anticipated or determined and the brake assemblies 16 are colder than desired. The performance mode may be selectable by a switch 60 actuated by an operator of the vehicle 10, and the switch 60 may be communicated with the controller 54 so the controller 54 can determine or is responsive the state/position of the switch 60.

Instead of or in addition, a switch 62 may be provided to enable manual control of providing conditioned air to a brake assembly 16. In one state of the switch 62, the controller 54 ensures conditioned air is provided to the second portion 46 of the air circuit 24 and to the brake assemblies 16 (e.g. the controller 54 causes or ensures the conditioned air source 20 is operating and that the valve 42 is in a suitable position). The switch 62 may have a second state in which system to provide conditioned air to a brake assembly 16 is turned off (e.g. the controller 54 causes or ensures that the valve 42 is in a suitable position).

Further, the vehicle 10 may be capable of determining performance of a brake assembly 16, for example, relative stopping power as a function of an input to a brake pedal. This may be done by a sensor 64 associated with the brake pedal or other portion of the brake assembly 16. Upon determining that the performance of a brake assembly 16 is below a threshold, the controller 54 may cause conditioned air to be directed to that brake assembly 16 or to multiple or all brake assemblies 16.

So arranged, the conditioned air source 20 may provide output air to at least one brake assembly 16, where the output air may be at a different temperature than air at an input to the conditioned air source 20 and/or ambient air surrounding the brake assembly 16 or in the environment outside of the vehicle 10. This may increase air flowing over at least part of the brake assemblies 16 to reduce (or increase if heated air is provided) the temperature of the brake assemblies 16 compared to a system that does not provide conditioned air to the brake assemblies 16. With better control of temperature, certain brake assembly 16 components, like rotors 28, may be made smaller while still providing suitable braking power.

What is claimed is:

1. A vehicle, including:
a wheel;
a brake assembly having a portion selectively engageable with the wheel to reduce the rate of rotation of the wheel or stop rotation of the wheel;
a conditioned air source providing an output air flow;
an air circuit in which the output air flow is directed, and wherein the air circuit includes a first outlet through which at least a portion of the output air flow is directed toward at least part of the brake assembly under at least some conditions of vehicle operation.

2. The vehicle of claim 1 wherein the conditioned air source is or includes: a) an air conditioner providing cooled air, and the output air flow includes air at a temperature below the temperature of an air input to the air conditioning assembly; or b) a heater providing heated air, and the output air flow includes air at a temperature above the temperature of ambient air.

3. The vehicle of claim 1 which also includes a valve associated with the air circuit, the valve having multiple positions and, when the valve is in at least one of the multiple positions, at least a portion of the output air flow does flow through the first outlet.

4. The vehicle of claim 1 which also includes a passenger compartment, and wherein the air circuit includes a second outlet communicated with the passenger compartment to provide at least part of the output air flow into the passenger compartment under at least some conditions of vehicle operation.

5. The vehicle of claim 1 wherein the brake assembly includes a rotor and a brake pad that is selectively engageable with the rotor, and wherein, when the output air flow flows through the first outlet, the output air flow is directed at the rotor.

6. The vehicle of claim 3 wherein the air circuit includes a second outlet spaced from the brake assembly and through which at least a portion of the output air flow is not directed at the brake assembly in at least one position of the valve.

7. The vehicle of claim 6 which includes a passenger compartment and wherein the second outlet is communicated with the passenger compartment to provide at least a portion of the output air flow to the passenger compartment in at least one position of the valve.

8. The vehicle of claim 7 wherein the valve controls the rate of the output air flow to the first outlet.

9. The vehicle of claim 7 wherein the valve is located between the first outlet and the second outlet.

10. The vehicle of claim 6 wherein the valve includes a third position, and when the valve is in the first position the output air flow flows through the first outlet, when the valve is in the second position the output air flow flows through the second outlet and when the valve is in the third position the output air flow flows through both the first outlet and the second outlet.

11. The vehicle of claim 3 which also includes a controller coupled to the valve to control when the valve is in the first position and when the valve is in the second position.

12. The vehicle of claim 11 which also includes a temperature sensor associated with at least part of the brake assembly, the temperature sensor is coupled to the controller, and wherein the controller is responsive to an output of the temperature sensor outboard of a threshold to cause the valve to be in the at least one position in which at least a portion of the output air flow does flow through the first outlet.

13. The vehicle of claim 12 wherein the controller is coupled to the conditioned air source and the controller provides a signal to turn on the conditioned air source if the conditioned air source is not then operating or to ensure the conditioned air source continues operating, to provide the output air flow from the conditioned air source.

14. The vehicle of claim 12 which includes multiple performance modes, and wherein in at least one of the multiple performance modes, the controller ensures the conditioned air source is operating to provide the output air flow and the valve is in said at least one position in which at least a portion of the output air flow does flow through the first outlet.

15. The vehicle of claim 11 which also includes a switch having multiple states, and wherein, in at least one state of the switch, the valve is in said at least one position in which at least a portion of the output air flow does flow through the first outlet, and wherein, in at least one other state of the switch, the valve is in a position that prevents the output air flow from flowing through the first outlet.
